(19) United States
(12) Patent Application Publication
(10) Pub. No.: US 2025/0045934 A1
(43) Pub. Date: Feb. 6, 2025

(54) Item Detection in FOV of Vision Camera of a Barcode Reader

(71) Applicant: ZEBRA TECHNOLOGIES CORPORATION, Lincolnshire, IL (US)

(72) Inventors: Yuri Astvatsaturov, Lake Forest, IL (US); Patrick Mauro, Lake Grove, NY (US)

(21) Appl. No.: 18/228,513

(22) Filed: Jul. 31, 2023

(51) Int. Cl. G06T 7/246; G06K 7/10; G06K 7/14; G06V 10/75

(52) U.S. Cl. CPC G06T 7/248; G06K 7/10861; G06K 7/1096; G06K 7/1491; G06V 10/751

(57) ABSTRACT

Methods, systems, and devices for locating and tracking an object in a machine vision field of view based upon an affixed indicium visible in an indicium decoding field of view are provided herein. An example method for object tracking includes receiving, from a first optical imaging assembly having a first field of view (FOV), a first image captured over the first FOV, receiving, from a second optical imaging assembly having a second FOV, a second image captured over the second FOV, decoding an indicium in the first image, detecting at least a portion of the indicium in the second image, and identifying an object of interest associated with the indicium in the second image based upon a location of the at least the portion of the indicium in the second image.

### BACKGROUND

Indicia decoding devices often include machine vision elements to gather and process information about the devices' surroundings beyond what is encoded on indicia presented to the devices. Often, machine vision imagery is captured and processed separately from decoding imagery, with decoding imagery captured and processed using configurations that emphasize speed and data accuracy, while machine vision imagery is generally captured with higher resolutions at the expense of processing speed and complexity. As such, these two subsystems generally do not communicate with each other much, if at all. This can present challenges when trying to perform coordinated actions that involve both machine vision elements and decoding subsystems.

### SUMMARY

Methods, systems, and devices are provided herein for locating and tracking an object in a machine vision field of view based upon an affixed indicium visible in an indicium decoding field of view.

In an example embodiment, the present invention is a method for object tracking, the method comprising receiving, from a first optical imaging assembly having a first field of view (FOV), a first image captured over the first FOV, receiving, from a second optical imaging assembly having a second FOV, a second image captured over the second FOV, decoding an indicium in the first image, detecting at least a portion of the indicium in the second image, and identifying an object of interest associated with the indicium in the second image based upon a location of the at least the portion of the indicium in the second image.

In a variation of this example embodiment, the detecting includes a visual identification of the indicium in the second image as having similar visual features to the indicium in the first image.

In a variation of this example embodiment, the method further comprises decoding at least a portion of the indicium in the second image, and wherein the detecting includes comparing payload data obtained from the decoding of the indicium in the first image with payload data obtained from the decoding of the at least the portion of the indicium in the second image to determine if at least a partial payload match exists, and determining that the indicium in the second image has been located responsive to a determination that the at least the partial payload match exists.

In a variation of this example embodiment, the method further comprises decoding at least a portion of the indicium in the second image, wherein the detecting includes comparing payload data obtained from the decoding of the indicium in the first image with payload data obtained from the decoding of the at least the portion of the indicium in the second image to determine if a complete payload match exists, and determining that the indicium in the second image has been located responsive to a determination that the complete payload match exist.

In a variation of this example embodiment, data from the first optical imaging assembly is sent to a first module that is configured with a first imaging algorithm, and data from the second optical imaging assembly is sent to a second module that is configured with a second imaging algorithm.

In a variation of this example embodiment, the first imaging algorithm decodes the indicium in the first image, and wherein the second imaging algorithm detects at least one object in the second image.

In a variation of this example embodiment, the method further comprises querying a database with payload data from the indicium in the first image, obtaining one or more first characteristics of an item associated with the payload data, wherein the first characteristics include at least one of a shape, a color, a curvature, a texture, a visual pattern, or a size, discerning one or more second characteristics of the object of interest corresponding with the first characteristics, and comparing the first characteristics with the second characteristics to determine whether the object of interest is the item associated with the payload data.

In a variation of this example embodiment, the method further comprises transmitting an alert responsive to a determination that the object of interest is not the item associated with the payload data.

In a variation of this example embodiment, the method further comprises employing image data from the first optical imaging assembly and image data from the second optical imaging assembly to train an artificial intelligence model responsive to a determination that the object of interest is the item associated with the payload data.

In a variation of this example embodiment, the first optical imaging assembly and the second optical imaging assembly are contained in a housing with a base portion and a raised portion, wherein the base portion includes a substantially horizontal platter area with a substantially horizontal window, and the raised portion includes a generally upright window.

In another example embodiment, the present invention is a system for object tracking, the system comprising a memory, a processing device, coupled to the memory, a first optical imaging assembly having a first field of view (FOV), configured to capture a first image over the first FOV, and a second optical imaging assembly having a second FOV, configured to capture a second image over the second FOV, wherein the processing device is configured to decode an indicium in the first image, detect at least a portion of the indicium in the second image, and identify an object of interest associated with the indicium in the second image based upon a location of the at least the portion of the indicium in the second image.

In a variation of this example embodiment, the processing device is configured to employ a visual identification of the indicium in the second image as having similar visual features to the indicium in the first image.

In a variation of this example embodiment, the processing device is further configured to decode at least a portion of the indicium in the second image, compare payload data obtained from the decoding of the indicium in the first image with payload data obtained from the decoding of the at least the portion of the indicium in the second image to determine if at least a partial payload match exists, and determine that the indicium in the second image has been located responsive to a determination that the at least the partial payload match exists.

In a variation of this example embodiment, the processing device is further configured to decode at least a portion of the indicium in the second image, compare payload data obtained from the decoding of the indicium in the first image with payload data obtained from the decoding of the at least the portion of the indicium in the second image to determine if a complete payload match exists, and determine that the indicium in the second image has been located responsive to a determination that the complete payload match exists.

In a variation of this example embodiment, data from the first optical imaging assembly is sent to a first module that is configured with a first imaging algorithm, and data from the second optical imaging assembly is sent to a second module that is configured with a second imaging algorithm.

In a variation of this example embodiment, the first imaging algorithm decodes the indicium in the first image, and wherein the second imaging algorithm detects at least one object in the second image.

In a variation of this example embodiment, the processing device is further configured to query a database with payload data from the indicium in the first image, obtain one or more first characteristics of an item associated with the payload data, wherein the first characteristics include at least one of a shape, a color, a curvature, a texture, a visual pattern, or a size, discern one or more second characteristics of the object of interest corresponding with the first characteristics, and compare the first characteristics with the second characteristics to determine whether the object of interest is the item associated with the payload data.

In a variation of this example embodiment, the processing device is further configured to transmit an alert responsive to a determination that the object of interest is not the item associated with the payload data.

In a variation of this example embodiment, the processing device is further configured to employ image data from the first optical imaging assembly and image data from the second optical imaging assembly to train an artificial intelligence model responsive to a determination that the object of interest is the item associated with the payload data.

In a variation of this example embodiment, the first optical imaging assembly and the second optical imaging assembly are contained in a housing with a base portion and a raised portion, wherein the base portion includes a substantially horizontal platter area with a substantially horizontal window, and the raised portion includes a generally upright window.

In yet another example embodiment, the present invention is a machine vision device, comprising a memory, a processing device, coupled to the memory, a first optical imaging assembly having a first field of view (FOV), configured to capture a first image over the first FOV, and a second optical imaging assembly having a second FOV, configured to capture a second image over the second FOV, wherein the processing device is configured to decode an indicium in the first image, detect at least a portion of the indicium in the second image, and identify an object of interest associated with the indicium in the second image based upon a location of the at least the portion of the indicium in the second image.

In a variation of this example embodiment, the processing device is configured to employ a visual identification of the indicium in the second image as having similar visual features to the indicium in the first image.

In a variation of this example embodiment, the processing device is further configured to decode at least a portion of the indicium in the second image.

In a variation of this example embodiment, data from the first optical imaging assembly is sent to a first module that is configured with a first imaging algorithm, and data from the second optical imaging assembly is sent to a second module that is configured with a second imaging algorithm.

In a variation of this example embodiment, the first optical imaging assembly and the second optical imaging assembly are contained in a housing with a base portion and a raised portion, wherein the base portion includes a substantially horizontal platter area with a substantially horizontal window, and the raised portion includes a generally upright window.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example indicia decoding device, according to embodiments of the present disclosure.

FIG. 2 illustrates a flowchart of an example method for indicium image processing, according to embodiments of the present disclosure.

FIG. 3 illustrates a section view of an example indicia decoding device, according to embodiments of the present disclosure.

FIG. 4 illustrates a data flow diagram of an example indicia decoding system, according to embodiments of the present disclosure.

FIG. 5 illustrates two fields of view of an example indicia decoding system viewing an object, according to embodiments of the present disclosure.

FIG. 6 illustrates two field of view of an example indicia decoding system viewing a pair of objects, according to embodiments of the present disclosure.

FIG. 7 illustrates a handheld indicia decoding device, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Methods, systems, and devices are provided herein for locating and tracking an object in a machine vision field of view based upon an affixed indicium visible in an indicium decoding field of view. When performing indicia decoding, it is often desirable to collect information about a decoding device's environment beyond that which is encoded on indicia passing through a field of view. Many devices and systems seek to obtain this additional information by including a machine vision subsystem separate from a traditional indicia decoding subsystem to capture and analyze images in ways that are outside of a scope of normal indicia decoding operations. In particular, many of these machine vision subsystems endeavor to locate and track objects moving through a field of view of the indicia decoding system.

These sorts of machine vision subsystems are particularly useful when collecting information about an object that is not encoded in an indicium, but can encounter problems when presented with multiple objects simultaneously. Self-checkout environments at grocery stores are a good illustration of potential problems of this nature: many situations arise where a first indicium on a first object is being decoded while a second object has also been placed or is also being held in a field of view of the machine vision subsystem. This can create ambiguity about what object the machine vision subsystem should be analyzing and may result in undesired behavior. Compounding the issues that arise when multiple objects are visible is a scenario where the second object has a second indicium affixed. In such a situation, additional analysis may need to be performed to ensure that an object being analyzed by a machine vision subsystem is a same item as that which bears an indicium which is currently being decoded.

As described in the present disclosure, a decoding subsystem can be configured to transmit a detected indicium, in decoded and/or encoded form, to the machine vision subsystem. The machine vision subsystem may then search for a matching indicium affixed to an object, allowing the machine vision subsystem to determine that this particular object is an object associated with an indicium which is currently being or has just been decoded. This may involve the vision subsystem wholly or partially decoding the indicium in order to verify that the indicium has been correctly located in a field of view of the vision subsystem. The vision subsystem may then segment (or otherwise identify) the object associated with the indicium out of a larger image and perform analysis of the object.

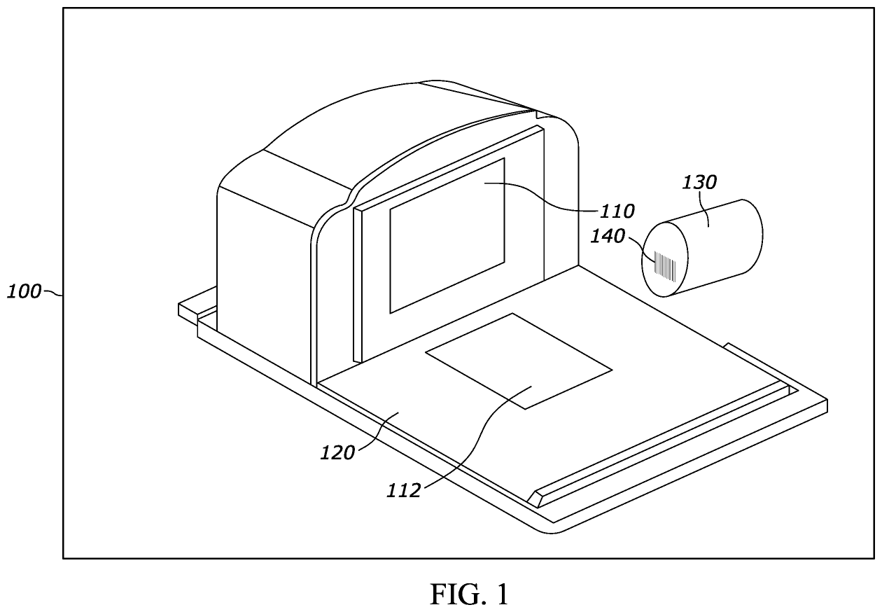

FIG. 1 illustrates an example indicia decoding device 100, according to embodiments of the present disclosure. The indicia decoding device 100 includes an upper window 110 and a lower window 112 configured to allow internal components of the indicia decoding device 100 to view a decoding region located above a platter 120. As an object 130 passes through the decoding region, the internal components of the indicia decoding device 100 capture images of the object 130 and locate and decode an indicium 140 affixed to a surface of the object 130. The internal components of the indicia decoding device 100 may also utilize captured images of the object 130 to determine one or more characteristics of the object 130.

The indicia decoding device 100 may include separate subsystems of components for performing indicia decoding and item detection and analysis. For example, an indicia decoding optical imaging assembly may transmit data to an indicia decode module, while a vision optical imaging assembly transmits data to a vision module.

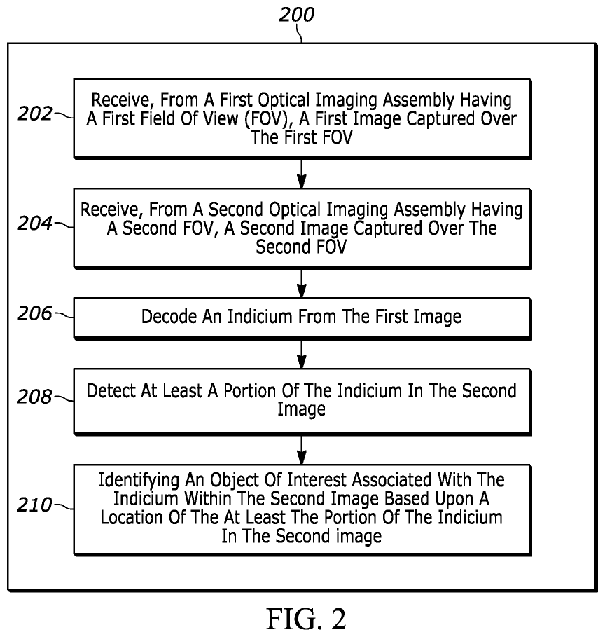

FIG. 2 illustrates a flowchart of an example method 200 for indicium image processing, according to embodiments of the present disclosure. It will be appreciated that the method 200 is presented with a high degree of abstraction, and that particular implementations of the method 200 may differ from that which is presented herein. In particular, additional steps not described herein may be included.

At block 202, an example first module receives, from a first optical imaging assembly having a first field of view (FOV), a first image captured over the first FOV. For example, a black-and-white camera configured to capture images of indicia in a decoding region may detect an indicium 140 affixed to an object 130 that has entered the decoding region, then send images of the indicium 140 to a decoding module for processing.

At block 204, an example second module receives, from a second optical imaging assembly having a second FOV, a second image captured over the second FOV. For example, a color camera configured to capture images of objects in the decoding region may detect motion in the decoding region and begin sending images of the decoding region to a vision module for processing. The second FOV and the first FOV may overlap. For example, the second FOV may have a 90% overlap with the first FOV. The overlap of the second FOV and the first FOV may, in some examples, be as low as 10% and as high as 100%.

At block 206, the first module decodes an indicium in the first image. For example, the decoding module may determine that the indicium 140 is a Universal Product Code (UPC) and an orientation of the UPC in a decoding FOV, then extract data encoded on the UPC.

At block 208, the second module detects at least a portion of the indicium in the second image. For example, the second module may locate an indicium in the second image that is only partially visible (e.g. a finger is obstructing half of the indicium) and decode visible portions of the indicium in the second image to determine that the indicium in the second image matches the indicium 140.

At block 210, the second module identifies an object of interest associated with the indicium in the second image based upon a location of the at least the portion of the indicium in the second image. For example, the second module may determine that a shape outline of an object 130 surrounds the indicium in the second image and determine that the indicium 140 is affixed to the object 130.

The second module may then perform analysis on the second image to determine whether the object 130 matches an expected item. For example, the second module may send an image of the object 130 to an artificial intelligence model to determine a name of the object 130.

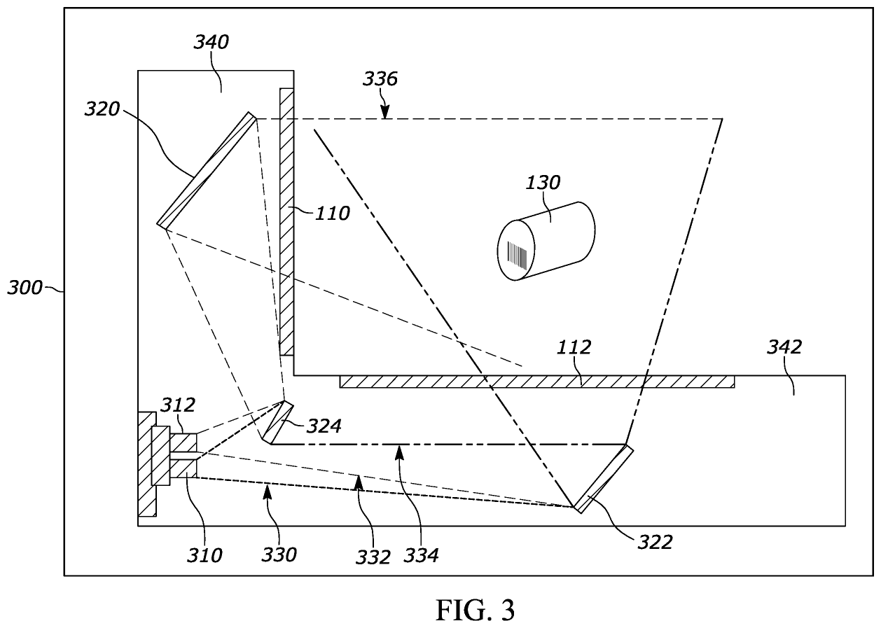

FIG. 3 illustrates a section view of an example indicia decoding device 300, according to embodiments of the present disclosure. The device 300 comprises a housing 342 with an upper portion 340, a first optical imaging assembly 310 with a first primary field of view (FOV) 330, a second optical imaging assembly 312 with a second primary FOV 332, a lower window 112, an upper window 110, a splitter mirror 324 that splits the first primary FOV 330 and the second primary FOV 332 into a lower FOV 334 and an upper FOV 336. The lower FOV 334 is directed toward a first fold mirror 322 that redirects the lower FOV 334 generally upward through the lower window 112 into a product scanning region. Separately, the upper FOV 336 is redirected by the splitter mirror 324 into an upper portion 340 of the housing 342 where a second fold mirror 320 redirects the upper FOV 336 in a generally horizontal direction through the upper window 110 and into the product scanning region. In this way, the first optical imaging assembly 310 and the second optical imaging assembly 312 may view an object 130 from two different angles at once, increasing a likelihood that an indicium affixed to the object 130 will be visible.

The first optical imaging assembly 310 may transmit a first image to a first module that is configured with a first imaging algorithm that decodes the indicium in the first image. The second optical imaging assembly 312 may similarly transmit a second image to a second module that is configured with a second imaging algorithm that detects at least one object in the second image. The second algorithm may also decode at least a portion of the indicium in the second image, compare payload data obtained from the decoding of the indicium in the first image with payload data obtained from the decoding of the at least the portion of the indicium in the second image to determine if a complete payload match exists, and determine that the indicium in the second image has been located responsive to a determination that the complete payload match exists.

For example, the first optical imaging assembly 310 may detect and image a GS1-128 indicium affixed to the object 130, then send the image containing the GS1-128 indicium to the first module. Separately, the second optical imaging assembly 312 may capture a second image and send the second image to the second module. The first module may send the payload of the decoded GS1-128 indicium to the second module, which may decode one or more indicia affixed to items visible in the second primary FOV 332 for comparison with the payload of the decoded GS1-128 indicium. Upon determining that an indicium of the one or more indicia affixed to items visible in the second primary FOV 332 contains payload data that completely matches the decoded GS1-128 indicium, the second module may segment an object 130 to which the indicium is affixed out of the second image and employ a convolutional neural network perform analysis on a segmented image of the object 130.

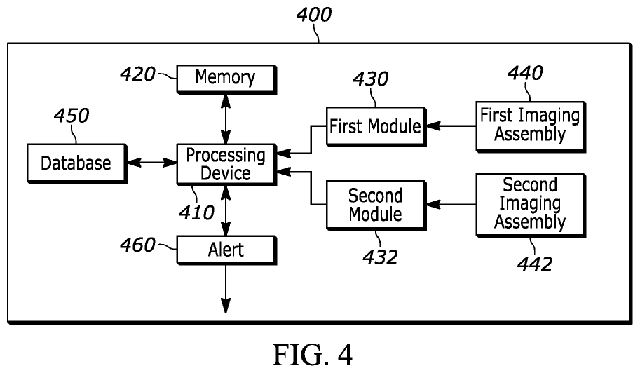

FIG. 4 illustrates a data flow diagram of an example indicia decoding system 400, according to embodiments of the present disclosure. The system 400 includes a memory 420, a processing device 410, coupled to the memory 420, a first optical imaging assembly 440 having a first field of view (FOV) configured to capture a first image over the first FOV, and a second optical imaging assembly 442 having a second FOV, configured to capture a second image over the second FOV. The first optical imaging assembly 440 sends the first image to a first module 430 which decodes an indicium in the first image and sends decoded payload data and the first image to the processing device 410. The processing device 410 then sends the first image to a second module 432. The second optical imaging assembly 442 sends the second image to the second module 432 which detects at least a portion of the indicium in the second image based on a visual identification of the indicium in the second image as having similar visual features to the indicium in the first image. For example, the indicium in the first image and the indicium in the second image may both be 1D barcodes. The second module 432 identifies an object of interest associated with the indicium in the second image based upon a location of the at least the portion of the indicium in the second image. The second module 432 may then segment the object of interest out of the second image and send a segmented image of the object of interest to the processing device 410.

The processing device 410 may query a local database 450 with the decoded payload data from the indicium in the first image, obtain one or more first characteristics of an item associated with the decoded payload data, discern one or more second characteristics of the segmented object of interest corresponding with the first characteristics, and compare the first characteristics with the second characteristics to determine whether the object of interest is the item associated with the decoded payload data. The first characteristics and the second characteristics may include but are not limited to one or more of a shape, a color, a curvature, a texture, a visual pattern, and a size.

When the processing device 410 determines that the object of interest is the item associated with the decoded payload data, the processing device 410 may send image data from the first optical imaging assembly 440 and image data from the second optical imaging assembly 442 to train an artificial intelligence model to identify the object of interest. When the processing device 410 determines that the object of interest is not the item associated with the decoded payload data, the processing device 410 may transmit an alert 460 indicative of an indicium-object mismatch to a host. The host may be a self-checkout kiosk, a cashier station, a user interface, or any other system capable of receiving the alert 460.

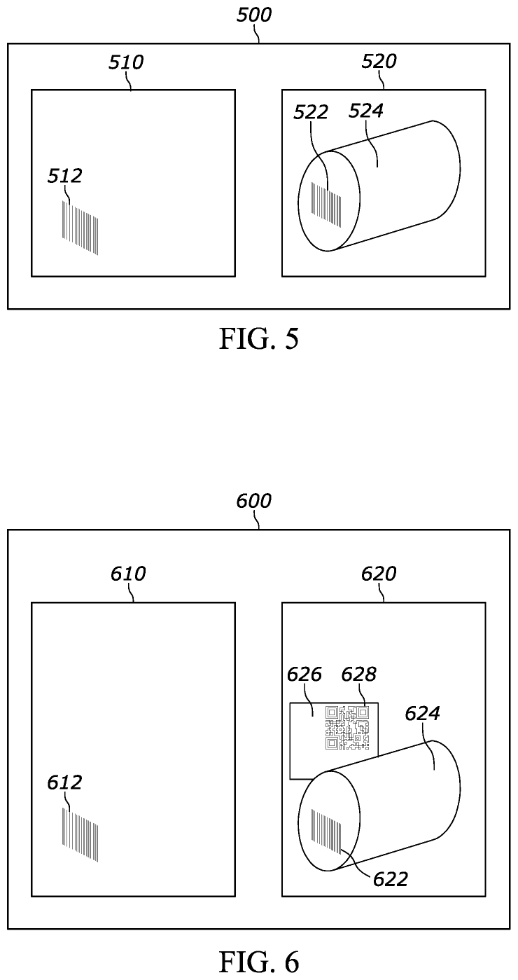

FIG. 5 illustrates two fields of view of an example indicia decoding system 500 viewing an object 524, according to embodiments of the present disclosure. A first image 510 containing a first indicium 512 is captured by a first imaging assembly and sent to a first module which is configured to decode a first payload data from the first indicium 512. A second image 520 containing an object 524 to which a second indicium 522 is affixed is captured by a second imaging assembly and sent to a second module. The second module is configured to receive the first payload data from the first module, determine that the second indicium 522 is visually similar to the first indicium 512 in the second image 520, decode the second indicium 522 to extract a second payload data, and compare the second payload data to the first payload data.

Upon determining that the second payload data matches the first payload data, the second module is configured to identify that the second indicium 522 is affixed to the object 524 and segment the second image 520 to create a segmented image that contains the object 524. The second module then sends the segmented image to a processing device, which queries a remote database with the first payload data to retrieve characteristics of an item associated with the first indicium 512 and determines corresponding characteristics of the object 524. When the characteristics of the item associated with the first indicium 512 match the characteristics of the object 524, the processing device may send a signal to a host verifying that the object 524 is associated with the first indicium 512. When the characteristics of the item associated with the first indicium 512 do not match the characteristics of the object 524, the processing device may send an alert to the host indicating that the object 524 is associated with the first indicium 512.

FIG. 6 illustrates two fields of view of an example indicia decoding system 600 viewing a pair of objects, according to embodiments of the present disclosure. A first image 610 containing a first indicium 612 is captured by a first imaging assembly and sent to a first module which is configured to decode a payload data from the first indicium 612. A second image 620 containing a first object 624 to which a second indicium 622 is affixed and a second object 626 to which a third indicium 628 is affixed is captured by a second imaging assembly and sent to a second module. The second module is configured to receive the first image 610 from the first module and determine that the second indicium 622 is more visually similar than the third indicium 628 to the first indicium 612 since the third indicium 628 is a 2D barcode while the first indicium 612 and the second indicium 622 are both 1D barcodes. The second module determines that the second indicium 622 is affixed to the first object 624, and segments the first object 624 out of the second image 620 to create a segmented image of the first object 624.

The second module may send the segmented image of the first object 624 to an artificial intelligence model that returns data about the first object 624. The data about the first object 624 can then be compared to the payload data to determine whether the first indicium 612 is associated with the first object 624. Responsive to a determination that the first indicium 612 is associated with the first object 624, a processing device may take no action. Responsive to a determination that the first indicium 612 is not associated with the first object 624, the processing device may halt all indicia decoding operations and transmit an alert to a host indicative of an object-indicium mismatch.

It should be appreciated while the present disclosure makes references to segmenting image data in response to detecting some aspects of an indicia in a certain FOV, segmentation is not required and other approaches for identifying portions of image data that is relevant to an item may be employed.

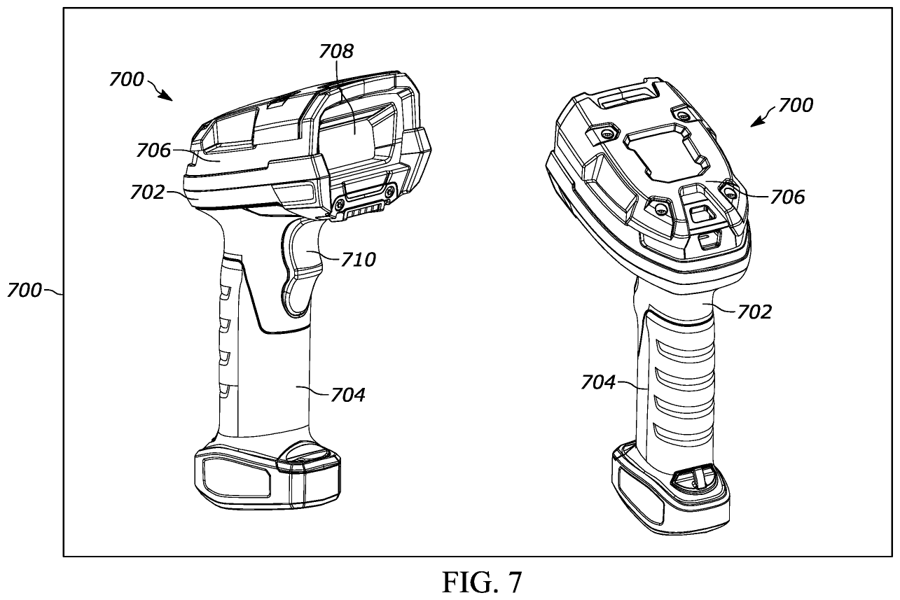

FIG. 7 illustrates an example barcode reader 700 having a housing 702 with a handle portion 704 and a head portion 706. The head portion 706 includes a window 708 and is configured to be positioned on the top of the handle portion 704. The head portion 706 includes an imaging lens that, depending on the implementation, is and/or includes a variable focus optical element. The head portion also includes a first optical imaging assembly configured to send data to a first module that decodes indicia and a second optical imaging assembly configured to send data to a second module that identifies at least one object in front of the window 708 (see FIG. 3).

The handle portion 704 is configured to be gripped by a reader user (not shown) and includes a trigger 710 for activation by the user. Optionally included in an embodiment is a base portion (not shown), which may be attached to the handle portion 704 opposite the head portion 706 and is configured to stand on a surface and support the housing 702 in a generally upright position. The barcode reader 700 can be used in a hands-free mode as a stationary workstation when it is placed on a countertop or other workstation surface. The barcode reader 700 can also be used in a handheld mode when it is picked up off the countertop or base station and held in an operator's hand. In the hands-free mode, products can be slid, swiped past, or presented to the window 708 for the reader to initiate barcode reading operations.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed:

1. A method for object tracking, the method comprising:
receiving, from a first optical imaging assembly having a first field of view (FOV), a first image captured over the first FOV;
receiving, from a second optical imaging assembly having a second FOV, a second image captured over the second FOV;
decoding an indicium in the first image;
detecting at least a portion of the indicium in the second image; and
identifying an object of interest associated with the indicium in the second image based upon a location of the at least the portion of the indicium in the second image.

2. The method of claim 1, wherein the detecting includes a visual identification of the indicium in the second image as having similar visual features to the indicium in the first image.

3. The method of claim 1, further comprising:
decoding at least a portion of the indicium in the second image, and wherein the detecting includes:
comparing payload data obtained from the decoding of the indicium in the first image with payload data obtained from the decoding of the at least the portion of the indicium in the second image to determine if at least a partial payload match exists; and
determining that the indicium in the second image has been located responsive to a determination that the at least the partial payload match exists.

4. The method of claim 1, further comprising:
decoding at least a portion of the indicium in the second image, wherein the detecting includes:
comparing payload data obtained from the decoding of the indicium in the first image with payload data obtained from the decoding of the at least the portion of the indicium in the second image to determine if a complete payload match exists; and
determining that the indicium in the second image has been located responsive to a determination that the complete payload match exists.

5. The method of claim 1, wherein data from the first optical imaging assembly is sent to a first module that is configured with a first imaging algorithm, and data from the second optical imaging assembly is sent to a second module that is configured with a second imaging algorithm.

6. The method of claim 5, wherein the first imaging algorithm decodes the indicium in the first image, and wherein the second imaging algorithm detects at least one object in the second image.

7. The method of claim 1, further comprising:
querying a database with payload data from the indicium in the first image;
obtaining one or more first characteristics of an item associated with the payload data, wherein the first characteristics include at least one of a shape, a color, a curvature, a texture, a visual pattern, or a size;
discerning one or more second characteristics of the object of interest corresponding with the first characteristics; and
comparing the first characteristics with the second characteristics to determine whether the object of interest is the item associated with the payload data.

8. The method of claim 7, further comprising:
transmitting an alert responsive to a determination that the object of interest is not the item associated with the payload data.

9. The method of claim 7, further comprising:
employing image data from the first optical imaging assembly and image data from the second optical imaging assembly to train an artificial intelligence model responsive to a determination that the object of interest is the item associated with the payload data.

10. The method of claim 1, wherein the first optical imaging assembly and the second optical imaging assembly are contained in a housing with a base portion and a raised portion, wherein the base portion includes a substantially horizontal platter area with a substantially horizontal window, and the raised portion includes a generally upright window.

11. A system for object tracking, the system comprising:
a memory;
a processing device, coupled to the memory;
a first optical imaging assembly having a first field of view (FOV), configured to capture a first image over the first FOV; and
a second optical imaging assembly having a second FOV, configured to capture a second image over the second FOV, wherein the processing device is configured to
decode an indicium in the first image,
detect at least a portion of the indicium in the second image, and
identify an object of interest associated with the indicium in the second image based upon a location of the at least the portion of the indicium in the second image.

12. The system of claim 11, wherein the processing device is configured to employ a visual identification of the indicium in the second image as having similar visual features to the indicium in the first image.

13. The system of claim 11 wherein the processing device is further configured to:
decode at least a portion of the indicium in the second image;
compare payload data obtained from the decoding of the indicium in the first image with payload data obtained from the decoding of the at least the portion of the indicium in the second image to determine if at least a partial payload match exists; and
determine that the indicium in the second image has been located responsive to a determination that the at least the partial payload match exists.

14. The system of claim 11, wherein the processing device is further configured to:
decode at least a portion of the indicium in the second image;
compare payload data obtained from the decoding of the indicium in the first image with payload data obtained from the decoding of the at least the portion of the indicium in the second image to determine if a complete payload match exists; and
determine that the indicium in the second image has been located responsive to a determination that the complete payload match exists.

15. The system of claim 11, wherein data from the first optical imaging assembly is sent to a first module that is configured with a first imaging algorithm, and data from the second optical imaging assembly is sent to a second module that is configured with a second imaging algorithm.

16. The system of claim 15, wherein the first imaging algorithm decodes the indicium in the first image, and wherein the second imaging algorithm detects at least one object in the second image.

17. The system of claim 11, wherein the processing device is further configured to:
query a database with payload data from the indicium in the first image;
obtain one or more first characteristics of an item associated with the payload data, wherein the first characteristics include at least one of a shape, a color, a curvature, a texture, a visual pattern, or a size;
discern one or more second characteristics of the object of interest corresponding with the first characteristics; and
compare the first characteristics with the second characteristics to determine whether the object of interest is the item associated with the payload data.

18. The system of claim 17, wherein the processing device is further configured to transmit an alert responsive to a determination that the object of interest is not the item associated with the payload data.

19. The system of claim 17, wherein the processing device is further configured to employ image data from the first optical imaging assembly and image data from the second optical imaging assembly to train an artificial intelligence model responsive to a determination that the object of interest is the item associated with the payload data.

20. The system of claim 11, wherein the first optical imaging assembly and the second optical imaging assembly are contained in a housing with a base portion and a raised portion, wherein the base portion includes a substantially horizontal platter area with a substantially horizontal window, and the raised portion includes a generally upright window.

21. A machine vision device, comprising:
a memory;
a processing device, coupled to the memory;
a first optical imaging assembly having a first field of view (FOV), configured to capture a first image over the first FOV; and
a second optical imaging assembly having a second FOV, configured to capture a second image over the second FOV, wherein the processing device is configured to
decode an indicium in the first image,
detect at least a portion of the indicium in the second image, and
identify an object of interest associated with the indicium in the second image based upon a location of the at least the portion of the indicium in the second image.

22. The machine vision device of claim 21, wherein the processing device is configured to employ a visual identification of the indicium in the second image as having similar visual features to the indicium in the first image.

23. The machine vision device of claim 21, wherein the processing device is further configured to decode at least a portion of the indicium in the second image.

24. The machine vision device of claim 21, wherein data from the first optical imaging assembly is sent to a first module that is configured with a first imaging algorithm, and data from the second optical imaging assembly is sent to a second module that is configured with a second imaging algorithm.

25. The machine vision device of claim 21, wherein the first optical imaging assembly and the second optical imaging assembly are contained in a housing with a base portion and a raised portion, wherein the base portion includes a substantially horizontal platter area with a substantially horizontal window, and the raised portion includes a generally upright window.
